(19) United States
(12) Patent Application Publication
(10) Pub. No.: US 2016/0258401 A1
(43) Pub. Date: Sep. 8, 2016

(54) FUEL INJECTOR

(71) Applicant: Caterpillar Inc., Peoria, IL (US)

(72) Inventors: Hoisan Kim, Dunlap, IL (US); Glenn B. Cox, Peoria, IL (US); Adrienne M. Brasche, Peoria, IL (US)

(73) Assignee: Caterpillar Inc., Peoria, IL (US)

(21) Appl. No.: 15/157,611

(22) Filed: May 18, 2016

(51) Int. Cl. F02M 51/06

(52) U.S. Cl. CPC F02M 51/0685; F02M 51/0628

(57) ABSTRACT

An actuator for a fuel injector provided. The actuator includes an armature that defines a socket. Further, the armature includes an end wall. The actuator also includes a pin that includes a first end and a second end. The first end is slidably received within the socket of the armature, and the second end is in contact with a valve element. The actuator further includes a first stop positioned within the socket between the first end and the end wall. The actuator includes a second stop disposed about a second end of the pin outside of the socket.

### TECHNICAL FIELD

The present disclosure relates to a fuel injector, and more particularly to the fuel injector associated with a fuel system of an engine.

### BACKGROUND

A solenoid valve associated with a fuel injector of an engine generally includes an armature. The armature is movable between a first position and a second position. Extreme ends of these first and second positions are often secured by mechanical stops. During operation of the solenoid valve, the armature is movable in one direction by an electro-magnetic force generated by a coil of wire, and in the opposite direction by a return spring. When the armature impacts one of the mechanical stops, it bounces or vibrates due to self weight or impact velocity. The bounce of the armature or a valve element of the fuel injector may cause undesirable opening or closing of a fuel inlet of the fuel injector. Further, the opening of the fuel inlet may lead to a leakage of a small amount of fuel into the engine, which may in turn result in change of emissions and may also affect fuel economy of the engine.

U.S. Pat. No. 8,967,502 hereinafter referred as the '502 patent, describes a dual fuel injector. The dual fuel injector includes a dual solenoid actuator that includes a first armature, a first coil, a second armature and a second coil that share a common centerline. The dual solenoid actuator has a non-injection configuration at which the first armature is at an un-energized position and the second armature is at an un-energized position. The dual solenoid actuator has a first fuel injection configuration at which the first armature is at an energized position and the second armature is at the un-energized position. The dual solenoid actuator has a second fuel injection configuration at which the first armature is at the un-energized position and the second armature is at an energized position. However, the fuel injector described in the '502 patent does not prevent the opening or closing of the fuel inlet due to vibrations.

### SUMMARY OF THE DISCLOSURE

According to an aspect of the present disclosure, an actuator for a fuel injector provided. The actuator includes an armature that defines a socket. Further, the armature includes an end wall. The actuator also includes a pin that includes a first end and a second end. The first end is slidably received within the socket of the armature, and the second end is in contact with a valve element. The actuator further includes a first stop positioned within the socket between the first end and the end wall. The actuator includes a second stop disposed about a second end of the pin outside of the socket.

### BRIEF DESCRIPTION OF THE DRAWINGS

FIG. 1 is a block diagram of a fuel system having a fuel injector, according to concepts of the present disclosure;

FIG. 2 is a partial sectional view of the fuel injector of FIG. 1;

FIG. 3 is an exploded view of a first actuator of the fuel injector of FIG. 2;

FIG. 4 is a perspective view of a first stop of the first actuator of FIGS. 3; and

FIG. 5 is a perspective view of a first second stop of the first actuator of FIG. 3.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

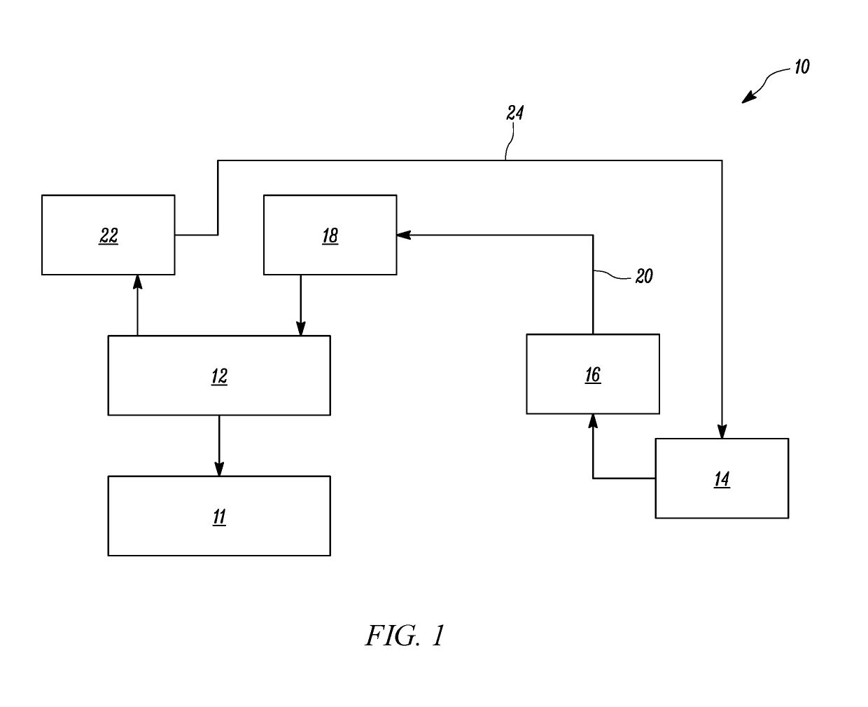

FIG. 1 depicts a fuel system 10 for supplying fuel to an engine 11, according to an embodiment of the present disclosure. The engine 11 may include one or more cylinders (not shown). More particularly, the fuel system 10 delivers fuel to combustion chamber defined in the one or more cylinders by one or more fuel injectors 12 disposed on a cylinder head (not shown) of the engine 11. The fuel system 10 includes a fuel tank 14 for storing fuel, such as gasoline, natural gas, and diesel. In an example, a plurality of the fuel tanks 14 may be used for storing more than one fuel, in case the engine 11 operates by dual fuels. The fuel tank 14 is in fluid communication with a fuel pump 16. The fuel pump 16 supplies the fuel stored in the fuel tank 14 to the one or more fuel injectors 12 through a fuel filter 18 by a fuel line 20. The fuel filter 18 filters the fuel from any contaminants. The fuel system 10 further includes a pressure regulator 22 that is in fluid communication with the one or more fuel injectors 12. The pressure regulator 22 is configured to regulate a pressure of fuel flowing within the fuel system 10 by bypassing fuel that is not delivered to the one or more cylinders of the engine 11 back to the fuel tank 14 by a return line 24.

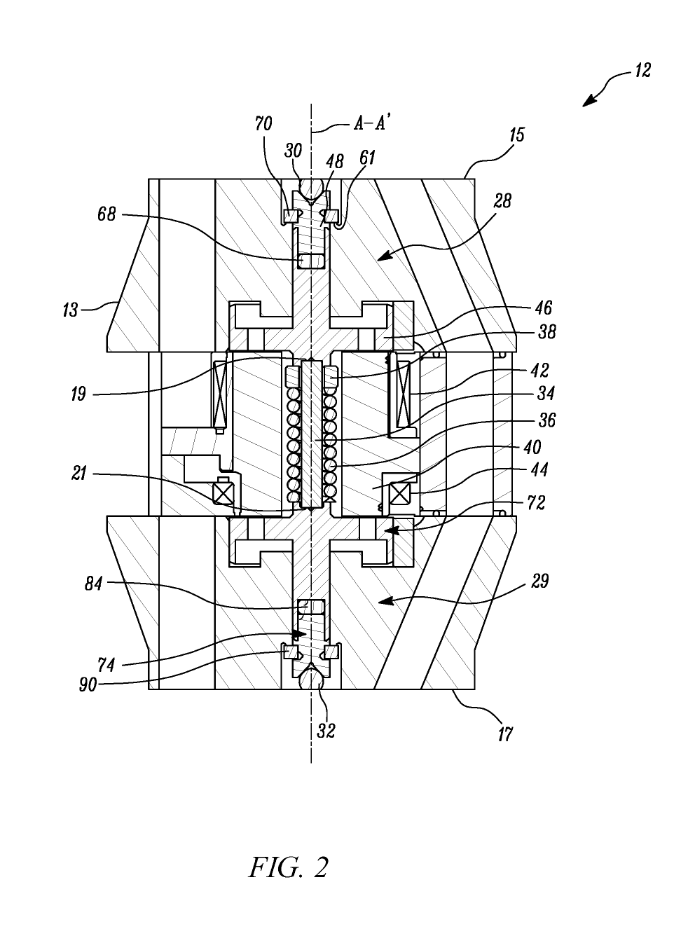

Referring to FIG. 2, a sectional view of one fuel injector 12 is shown for illustration purpose of the present disclosure. However, it is contemplated that the present disclosure is equally applicable to all the fuel injectors 12 of the engine 11. In the present embodiment, the fuel injector 12 injects dual fuels into the combustion chamber of the one or more cylinders of the engine 11. The fuel injector 12 includes an injector body 13. In an example, the injector body 13 may be a tubular housing made from a non-magnetic stainless steel. The injector body 13 has a first end 15 and a second end 17.

In the present embodiment, the fuel injector 12 includes a first actuator 28 and a second actuator 29 disposed within the injector body 13 adjacent to the first end 15 and the second end 17, respectively. The first and second actuators 28, 29 are disposed within the injector body 13 axially against a first end 19 and a second end 21 of a cylindrical member 34 along a longitudinal axis A-A of the injector body 13. The fuel injector 12 further includes a first valve element 30 and a second valve element 32 disposed adjacent to the first end 15 and the second end 17, respectively. The first and second valve elements 30, 32 allow fuel supply from a high pressure fuel rail (not shown) to the cylinders of the engine 11. The first and second valve elements 30, 32 are actuated by the first and second actuators 28, 29. Further, the first and second valve elements 30, 32 reduce the pressure from a check (needle) (not shown) within the high pressure fuel rail to supply the respective fuel to the cylinders of the engine. The first and second valve elements 30, 32 supply dual fuels to the cylinders of the engine 11. The cylindrical member 34 is disposed within a spring member 36. The spring member 36 is disposed between the first and second actuators 28, 29. The spring member 36 biases the first and second actuators 28, 29 to move the first and second valve elements 30, 32 to a closed position thereof.

A spring preload spacer 38 is slidably received over the cylindrical member 34 along the longitudinal axis Further, the spring preload spacer 38 is disposed adjacent to the first end 19 of the cylindrical member 34 between the first actuator 28 and the spring member 36.

The injector body 13 further includes a stator member 40 disposed within the injector body 13 around the spring member 36. The stator member 40 mounts a first coil 42 and a second coil 44 that generate a magnetic field for actuating the first and second actuators 28, 29. The first and second valve elements 30, 32 can be actuated based on magnetic field generated within the stator member 40 and the cylindrical member 34. The magnetic field may be further controlled based on a supply of electric power to the first coil 42 and the second coil 44.

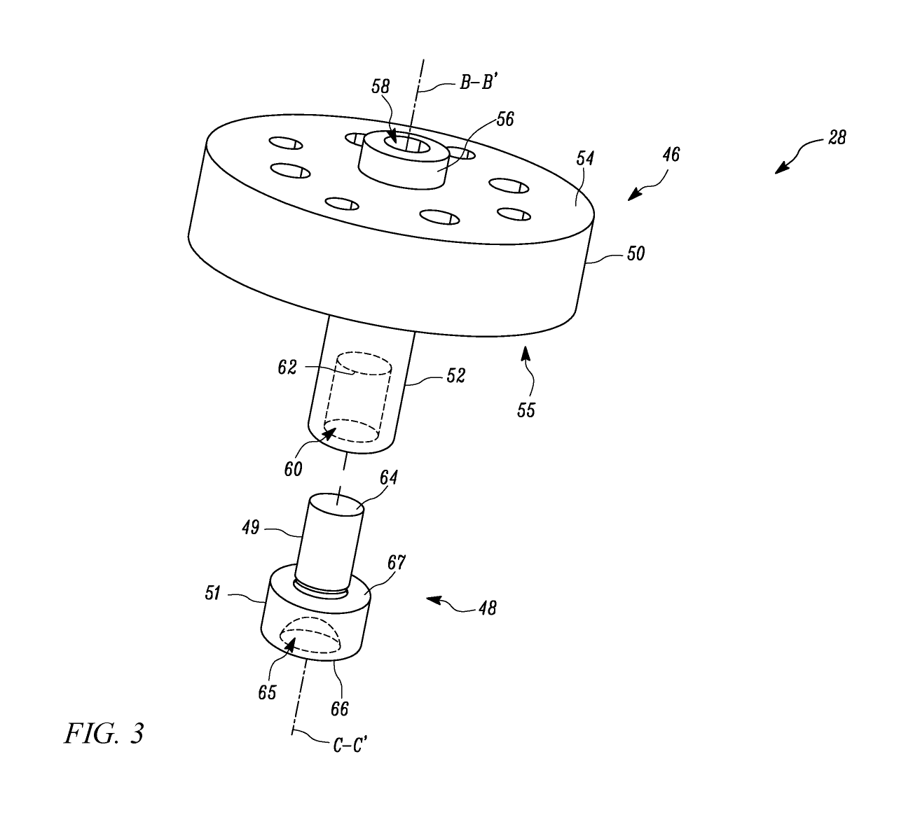

A perspective view of the first actuator 28 is shown in FIG. 3 for illustration purpose of the present disclosure. The first actuator 28 includes a first armature 46 and a first pin 48. The first armature 46 includes a first cylindrical portion 50 and a second cylindrical portion 52 extending from the first cylindrical portion 50 along a central axis B-B′ thereof. The first cylindrical portion 50 has a diameter greater than a diameter of the second cylindrical portion 52. In the present embodiment, the second cylindrical portion 52 is integrally formed with the first cylindrical portion 50. The first armature 46 is disposed within the injector body 13 in such a way that the central axis B-B′ of the first cylindrical portion 50 becomes coaxial to the longitudinal axis A-A′ of the injector body 13. In an example, the first cylindrical portion 50 and the second cylindrical portion 52 can be separate components that may be coupled coaxially along the central axis B-B′ of the first cylindrical portion 50.

The first cylindrical portion 50 includes a first surface 54 and a second surface 55 distal to the first surface 54. The second cylindrical portion 52 is extending from the second surface 55 of the first cylindrical portion 50. A protruding member 56 is extending from the first surface 54 along the central axis B-B′ thereof The protruding member 56 includes a blind hole 58 receives the first end 19 of the cylindrical member 34. The second cylindrical portion 52 of the first armature 46 includes a first socket 60. In the present embodiment, the first socket 60 has a circular cross section. In various examples, cross section of the first socket 60 may be a square, a polygon or any other shape known in the art. The first armature 46 includes an end wall 62 defined inside the first socket 60.

The first pin 48 includes a first cylindrical portion 51 and a second cylindrical portion 49 extending from the first cylindrical portion 51 along a central axis C-C′ thereof. The first cylindrical portion 51 has a diameter greater than a diameter of the second cylindrical portion 49. In the present embodiment, the second cylindrical portion 49 is integrally formed with the first cylindrical portion 51. In an example, the first cylindrical portion 51 and the second cylindrical portion 49 can be separate components that may be coupled coaxially along the central axis C-C′ of the first cylindrical portion 51.

The first pin 48 includes a first end 64 defined by the second cylindrical portion 49 and a second end 66 defined by the first cylindrical portion 51. The first end 64 of the first pin 48 slidably receives within the first socket 60 of the first armature 46. The first cylindrical portion 51 defines a step portion 67 with respect to the second cylindrical portion 49. The first cylindrical portion 51 of the first pin 48 further defines a first void member 65 to receive at least a portion of the first valve element 30.

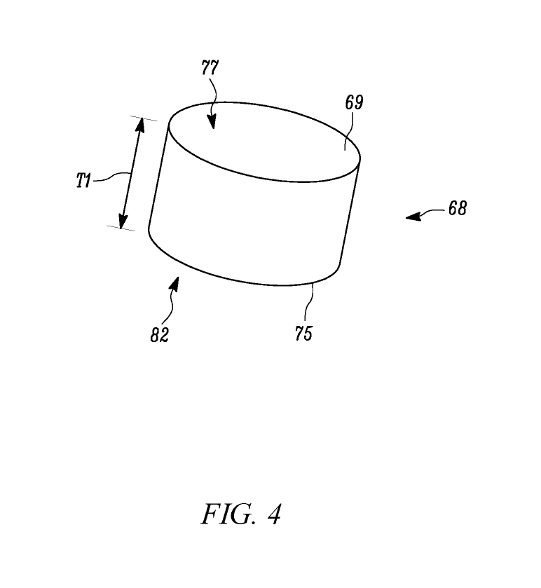

FIG. 4 depicts a perspective view of a first stop 68 positioned within the first socket 60 of the first armature 46. More specifically, the first stop 68 receives within the end wall 62 of the first socket 60 and the first end 64 of the first pin 48, in the present embodiment, the first stop 68 is a cylindrical body having an outer diameter smaller than an inner diameter of the first socket 60. The first stop 68 further includes a first end 69 and a second end 75 defining a first thickness ‘T1’. A first surface 77 is defined at the first end 69 and a second surface 82 is defined at the second end 75. The first surface 77 abuts the end wall 62 of the first socket 60 and the second surface 82 abuts the first surface 77 of the first pin 48.

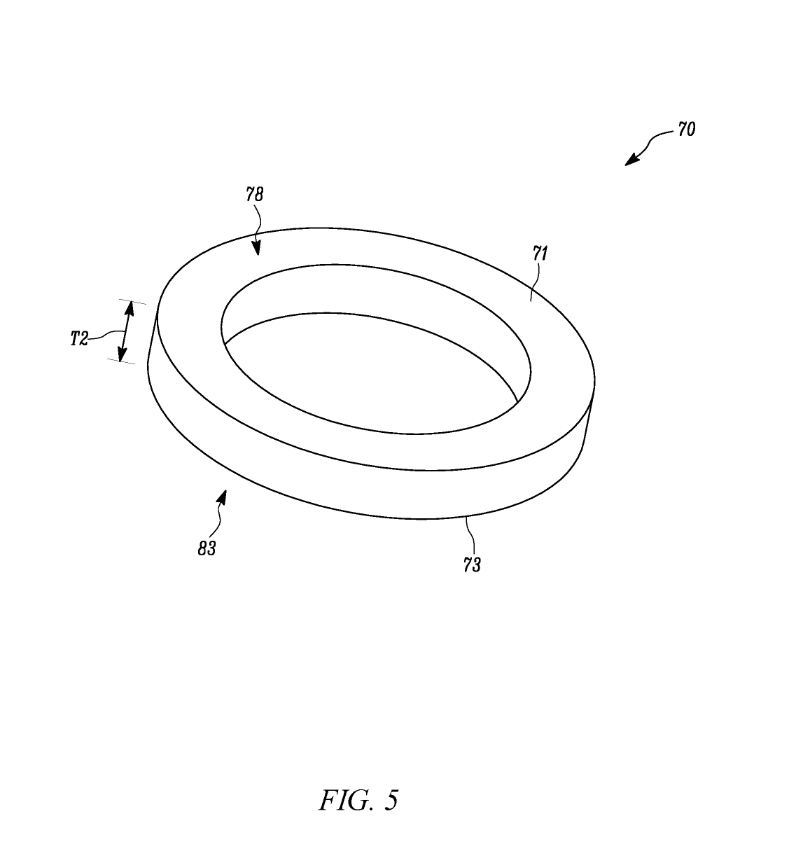

FIG. 5 depicts a perspective view of the second stop 70 surrounding the step portion 67 of the second cylindrical portion 49 defined adjacent to the first cylindrical portion 51. The second stop 70 includes a first surface 71 contacts a step portion 61 (shown in FIG. 2) defined in the injector body 13. The second stop 70 includes a second surface 73 abuts the step portion 61 defined by the first cylindrical portion 51 of the first pin 48. The second stop 70 has a second thickness ‘T2’ defined between the first surface 78 and the second surface 80. The second stop 70 dampens vibrations between the first armature 46 and the first pin 48 during operation of the engine 11. The first thickness ‘T1’ of the first stop 68 and the second thickness ‘T2’ of the second stop 70 are defined in such a way to locate the first pin 48 relative to the first armature 46 in a predefined position within the injector body 13.

Referring to FIG. 2, the second actuator 29 also includes a second armature 72 and a second pin 74. Construction of the second armature 72 and the second pin 74 is identical to the construction of the first armature 46 and the first pin 48 described above. The second actuator 29 also includes a first stop 84 and a second stop 90. The construction of the first stop 84 and the second stop 90 is identical to the construction of the first stop 68 and the second stop 70 described with reference to FIG. 4 and FIG. 5, respectively. The first stop 84 and the second stop 90 are defined in such a way to locate the second pin 74 relative to the second armature 72 in a predefined position within the injector body 13.

The fuel system 10 operates in three configurations to control the fuel supply to the engine 11. In a first configuration, the fuel is restricted to be injected into the engine 11. More particularly, the first and second actuators 28, 29 are biased by the spring member 36 and the first and second valve elements 30, 32 are in a closed position.

In a second configuration, a single fuel is injected into the fuel injector

The injection of the first fuel into the engine 11 is controlled by the second actuator 29. The fuel injection is initiated by energizing the second coil 44. The energized second coil 44 pulls the second armature 72 of the second actuator 29 upwards and towards an open position. The second armature 72 along with the second pin 74, the first stop 84, and the second stop 90 moves upwards against the spring member 36 until the movement of the second actuator 29 is arrested by a stopper (not shown). Further, the second valve element 32 opens thereby allowing the supply of the first fuel into the engine 11 for combustion. It may be contemplated that the working of the first actuator 28 to control the supply of the second fuel is similar to the working of the second actuator 29 that is described above.

In a third configuration, dual fuels are injected by the fuel injector 12. FIG. 2 depicts the third configuration where both the fuels are injected in to the combustion chamber. The fuel injection is initiated by energizing the first and second coils 42, 44. The energized first and second coils 42, 44 move the first and second actuators 28, 29 towards the cylindrical member 34, The first and second actuators 28, 29 are moved until the blind hole 58 of the first armature 46 and the blind hole (not shown) of the second armature 72 receives the cylindrical member 34. The movement of the first and second actuators 28, 29 may in turn causes the first and second valve elements 30, 32, respectively to open, thereby allowing the supply of both the fuels into the engine 11 for combustion purposes.

### INDUSTRIAL APPLICABILITY

The present disclosure relates to the fuel injector 12 having the first and second actuators 28, 29. The first and second actuators 28, 29 includes the first and second armatures 46, 72, and the first and second pins 48, 74, for moving the first and second valve elements 30, 32, respectively between the open position and the closed position thereof. The first stops 68, 84 and the second stops 70, 90 are used for locating the first and second pins 48, 74 in the predefined position within the injector body 13 so that any undesired displacement of the first and second valve elements 30, 32 may be avoided in the closed position of the first and second valve elements 30, 32.

When the first actuator 28 is energized, the first stop 68 absorbs the vibrations between the first armature 46 and the first pin 48. Similarly, when the second actuator 29 is energized, the first stop 84 absorbs the vibrations between the second armature 72 and the second pin 74. When the engine 11 is exposed to sudden external impacts, the first and second stops 70, 90 of the first and second actuators 28, 29 absorb the effect of the impact thereby preventing the first and second valve elements 30, 32 from bouncing. Thus, leakage of the fuel from the fuel injector 12 to the combustion chamber of the one or more cylinders may be avoided, when the first and second valve elements 30, 32 are in the closed position. Further, undesired entry of the fuel into the engine 11 is prevented by restricting any movement of the first and second valve elements 30, 32, thereby improving fuel efficiency of the engine 11.

The first and second stops 70, 90 further provide uniform loading on the first and second pins 48, 74 respectively. The assembly of the first and second armatures 46, 76 and the first and second pins 48, 74 are lighter in weight as compared to conventional systems. The first and second stops 70, 90 also ensure alignment between the first and second armatures 46, 76 and the first and second pins 48, 74 during operation of the engine 11.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An actuator for a fuel injector, the actuator comprising:
an armature defining a socket, wherein the armature includes an end wall;
a pin including a first end and a second end, wherein the first end is slidably received within the socket of the armature, and the second end is in contact with the a valve element;
a first stop positioned within the socket between the first end and the end wall; and
a second stop disposed about a second end of the pin outside of the socket.
